(19) United States
(12) Patent Application Publication
(10) Pub. No.: US 2008/0135698 A1
(43) Pub. Date: Jun. 12, 2008

(54) Rack system

(75) Inventor: Mel Gordon, Center Harbor, NH (US)

Correspondence Address: WOLF GREENFIELD & SACKS, P.C., 600 ATLANTIC AVENUE, BOSTON, MA, 02210-2206, US

(73) Assignee: Tootsie Roll Industries, Inc., Chicago, IL (US)

(21) Appl. No.: 11/636,942

(22) Filed: Dec. 11, 2006

(51) Int. Cl. F16M 11/20; A47F 10/02; A47F 3/14

(52) U.S. Cl. 248/188.1; 186/57; 211/126.15

(57) ABSTRACT

A display stand for the commercial aisle display in a retail store of like boxed items, comprising an array of individual tray assemblies positioned side by side with a plurality of such side by side assemblies stacked one above the other in spaced relation.

### BACKGROUND OF THE INVENTION

The present invention relates to a packaging system and, more particularly, to a system for loading, shipping and displaying boxed items.

The shipment of boxed items from manufacturing and assembly locations to retail locations frequently involves expensive assembly and packaging of the boxed items for shipment and removal of the boxed items and packaging once the goods reach the retail location from which they are to be dispensed. Pallets are commonly used for these shipments. In these existing arrangements, pallets are loaded with a number of stacked boxed items in a vertical array with the pallets suitably boxed and wrapped for shipment. Frequently, the boxed items are pre-packed in cartons for storage at the retail location until the boxed items are removed and placed on store shelves or onto floor displayers. When the pallets arrive at the ultimate destination, the wrapping is removed, the boxes or cartons are placed in storage or as needed into shelves or retail display units, and the pallet, itself, is either recycled or destroyed. Such a procedure is time consuming in that it requires both assembly and disassembly of the packaging onto the pallets and further involves a great deal of handling when moving the individual boxed items or cartons from the pallets to a retail display area. These limitations require a lot of store labor, incur additional delays and costs and in some instances contribute to lost inventory when multiple cartons get separated in warehouses or stores, or where cartons to fill a self-service floor display get separated from the floor display, or are shipped separately.

### BRIEF SUMMARY OF THE INVENTION

It is an object of the present invention to provide a packaging system for factory production line assembly, shipping, and retail display of a number of like boxed items using a minimum of store labor and store handling.

In the present invention, an assembly of a plurality of stackable trays are arrayed in lateral relation to one another and also in a stacked configuration, with the assembly supported on a conventional shipping pallet, often half or quarter pallets. The individual tray on one level is spaced from the trays in the next adjacent level by dowels or supports which inter-engage portions of the trays to form supporting members. The trays are further provided with several built-in dividers that permit a plurality of individual boxed, same sized items to be arranged upon each tray. When initially shipped, the stackable trays are positioned on the pallet and are contained within a large shipping container having a bottom closure at its lower end, which is shaped and sized to provide a printed cover for the raw front, back, and sides of the pallet when the unit is on display.

The foregoing structure as generally described is intended to provide an improved shipping system for transporting boxed items such as boxes of candy and other items from a manufacturing facility to a retail outlet where the boxed display may be readily displayed within the retail outlet on its original pallet with the entire display providing custom accessibility from two or four sides and with the display, itself, having an attractive and finished retail store appearance. Since the display is factory assembled, one person can position the pallet for sale and remove the packing in a few minutes using a hand lift.

A further object of the present invention is to provide an improved pallet display for use in retail store or like operations in which the contents of a display are efficiently and simply packaged and displayed and in which the display unit, itself, is permanent enough to be restocked and re-used once the contents have been sold or otherwise dispensed.

A further object of the present invention is to provide a stackable array of trays designed to hold and readily display individual boxed goods such as candies, foods, hardware or other products, in an aisle display or, in some instances, as a counter display.

A further object of the present invention is to provide an improved display system for packing and shipping boxed goods, with the display units inexpensive to make, assemble and store. A further object of the present invention is to provide an improved display system for boxed goods in which the various units may be re-usable. The simple erector-style principles of the display allow store personnel to reconfigure each rack of the display by adding or subtracting layers from the racks as the display sells down to avoid empty layers.

A further objective of the present invention is to permit two-high stacking of pallet displays in trucks or warehouses to reduce trucking charges and save warehousing space. The top and bottom caps on each pallet plus the surrounding corrugated side shrowds and shrink wrap keep the unit intact and protect it from shipping and handling damage. Factory strapping each horizontal row of boxes to the plastic layer prevents boxes from falling out in shipping, even if cartons are inverted.

### BRIEF DESCRIPTION OF THE DRAWINGS

FIG. 1 is a perspective view of a complete package ready for shipment from a manufacturing facility to a retail facility;

FIG. 2 is a perspective view of the package partially opened as it would occur at the retail store site;

FIG. 3 is a perspective view of the package with the shipping cartons removed;

FIG. 4 is a perspective view of the package fully assembled for retail display;

FIG. 5 is an exploded perspective view of one of a number of like stackable trays that are assembled into the display;

FIG. 6 is a fragmentary perspective view of the display, with a skirt partially assembled;

FIG. 7 is a fragmentary, perspective view of the display, showing a detailed assembly of the skirt.

The accompanying drawings are not necessarily intended to be drawn to scale. In the drawings, each identical and nearly identical component that is illustrated in various figures is represented by a like number. For purposes of clarity, not every component may be labeled on every drawing.

### DETAILED DESCRIPTION OF THE INVENTION

The invention is not limited in this application to details of construction and the arrangement of components set forth in the following description or illustrated in the drawings. The invention is capable of other embodiments and of being practiced or being carried out in various ways. Also, the phraseology and terminology used herein is for purposes of description and should not be regarded as limited. The use of “including,” “comprising,” “havining,” “involving,” and variations therein is meant to encompass the items listed thereafter and equivalents thereof, as well as additional items unless otherwise expressly stated. Additionally, the embodiments are intended to be illustrative of a variety of sizes and shapes for holding small to large discrete boxed items.

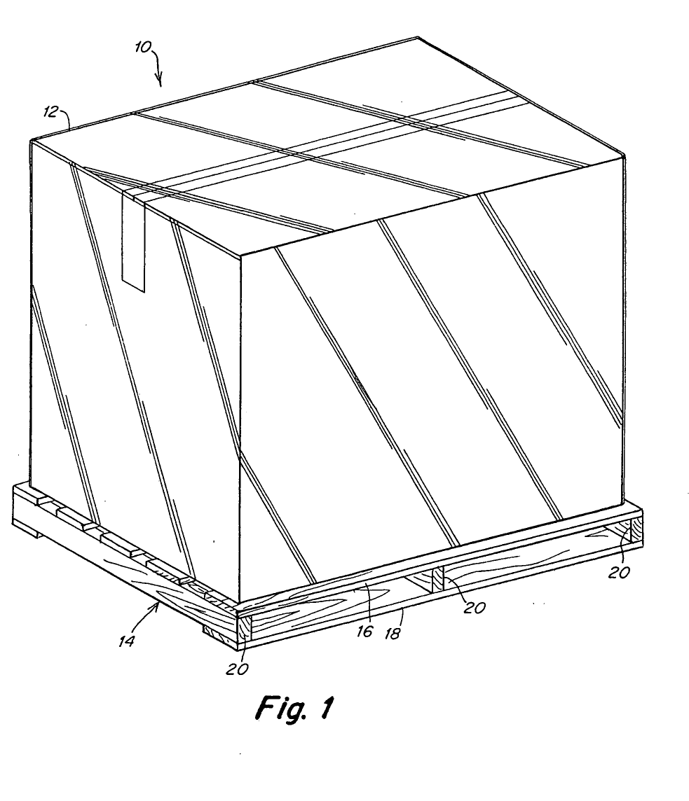

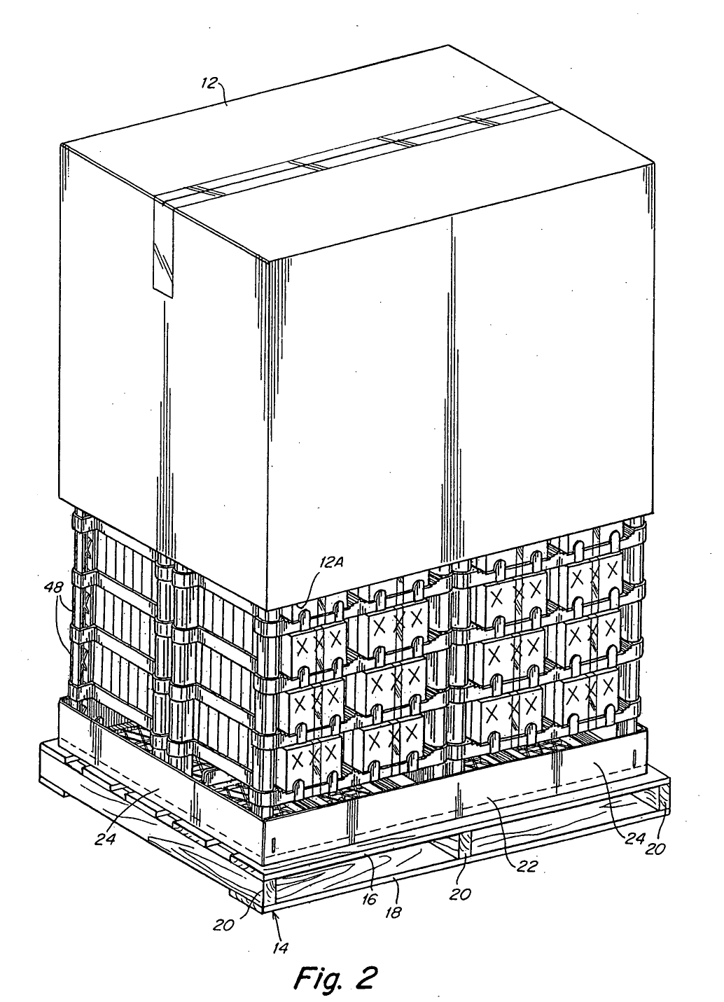

As illustrated in FIG. 1, a display package 10 ready for shipment comprises a shipping carton 12 wrapped within a sheet of plastic wrapping in a conventional fashion for pallet shipments. The carton 12 is positioned on a pallet 14. The pallet 14 may be of conventional size, shape, and manufacture and includes, as illustrated, the standard wooden upper platform 16 supported and spaced from a base 18 by means of support spacers 20 of various types. For example, a full pallet is about 48″×40″; a half pallet is about 24″×40″; and a quarter pallet is about 20″×24″ or any pallet size suitable to the rack configuration. The present system allows for stacking of pallets to maximize shipping space. As illustrated in FIG. 2, the carton 12 is open at its bottom end 12a but otherwise appears as a standard shipping carton. A cap or skirt 22 rests on the upper surface of the upper platform 16, and when shipped is provided with (four rectangularly arranged vertically extending walls) 24 which extend upwardly to engage, in facing relation, the bottom end 12a of the shipping carton 12 when in shipment.

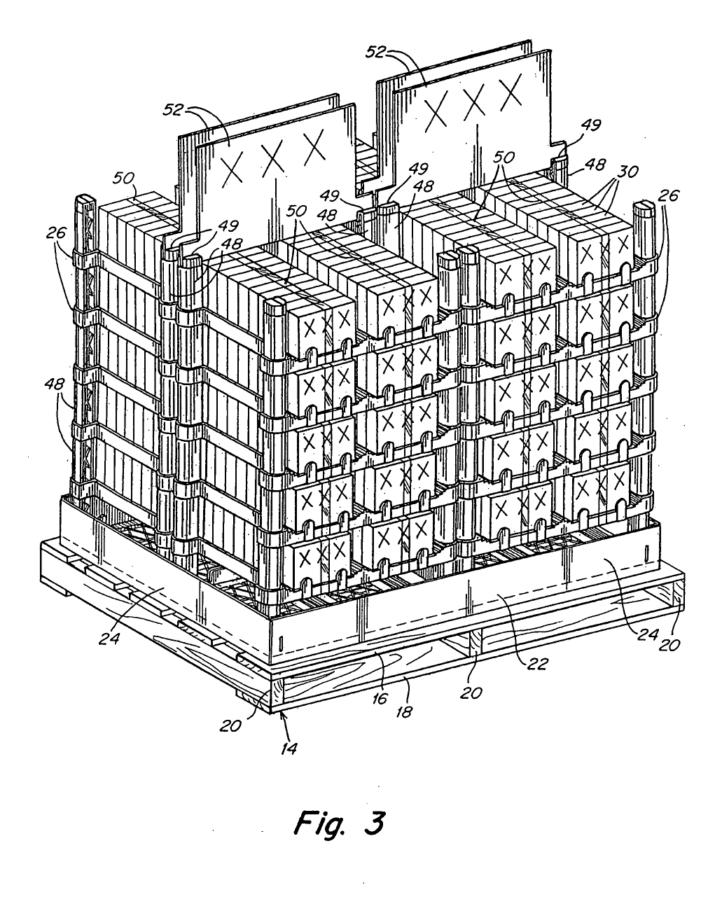

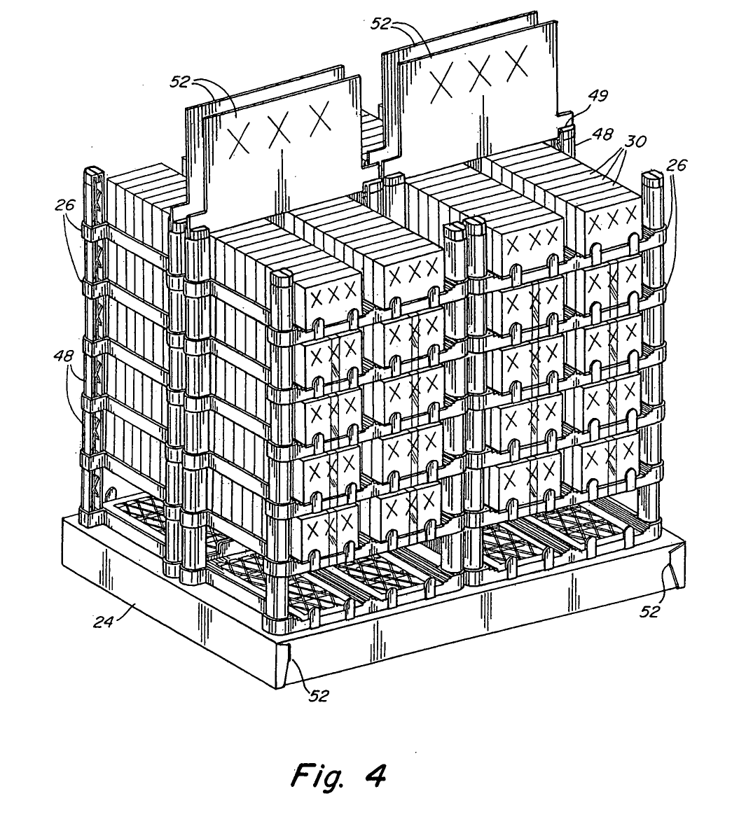

When the display package is shipped and the shipping carton 12 removed as shown partially in FIG. 2, the cap or skirt 22 remains seated on the upper platform 16 as illustrated in FIG. 2. As best illustrated in FIG. 3, the display package consists of a plurality of visible and accessible individual tray assemblies 26 when prepared for retail store display. In the embodiments shown in FIGS. 3 and 4, there is provided a stack of six levels of tray assemblies which collectively may be referred to as a rack. On each of the separate stack levels, there are provided four tray assemblies 26 configured in side-by-side arrangement to provide a rectangular array as shown in plan view. In other embodiments four or more or less tray assemblies 26 are contemplated. Four racks comprises a half pallet, two racks form a quarter pallet, and single racks may be desired as well.

Each of these tray assemblies 26 are identical one to the other and are formed from a plurality of like components which may be readily assembled and interchanged to form the tray assemblies 26 in a stackable array.

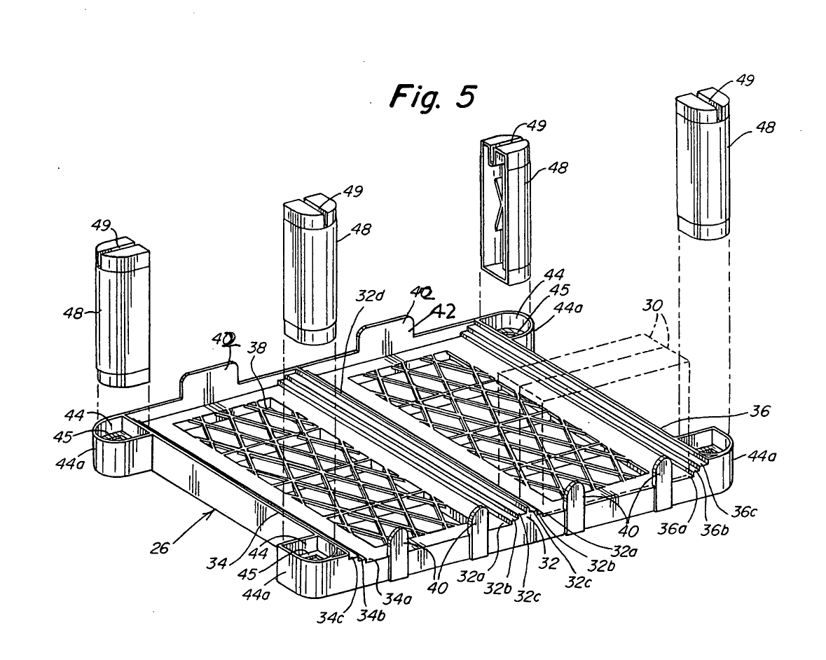

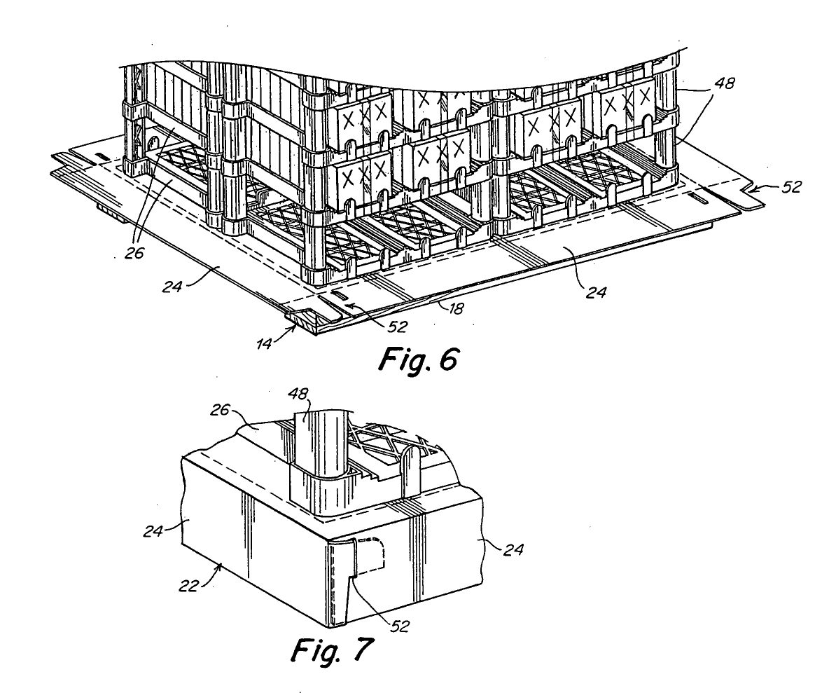

FIG. 5 illustrates an individual, tray assembly 26. The tray assembly 26 includes a horizontally extending tray 28 preferably having a generally rectangular shape and having an upper and lower surface. Each tray is sized and shaped to receive a plurality of like boxes 30 sized to contain a retail product or products on the upper surface. In this instance, the specific embodiment illustrates a tray 28 sized and shaped to receive candy boxes having generally dimensions of in the order of four inches high, six inches wide, and one inch deep. Such a size is illustrative only and may be varied over a considerable range, depending upon the particular products to be displayed. In the embodiment of FIG. 5, the tray 28 is shaped and sized to receive two parallel rows of boxes 30 positioned side by side and separated with the two rows of boxes separate one from the other by a longitudinally extending guide 32. The guide 32 is symetrically and centrally located on the tray 28 and may be integrally formed with it. Side guides 34 and 36 extend longitudinally of the tray and are parallel with and uniformly spaced on either side of the longitudinally extending guide 32. The guide 32 and side 34 position a longitudinal array of boxed goods, while guide 32 and side guide 36 similarly support a like row of boxed goods in parallel relation to the first. The side guides 34 and 36 and the center guide 32 may be stepped to accommodate boxes of different widths. Thus, for example, the guide 32 is shaped with symetrically arranged steps 32a, 32b, and 32c on either side of a center divider 32d. Side guides 34 and 36 have similarly arranged and sized steps formed only on the inner side of the guides 34 and 36. These steps 32a, 32b, and 32c and 34a, 34b, and 34c are positioned in spaced parallel relation to one another, with the steps of the same depth and height. Likewise, steps 36a, 36b, and 36c are similarly related in size and space to steps 32a, 32b, and 32c. The spacing between the longitudinally extending center guide and the two side guides 34 and 36 is sized to receive selectively standard boxes of different sizes. Thus, for example, boxes 30 may be located between the vertical surfaces of steps 32a and 34a and 32a and 36a. Larger boxes may be accommodated on the next highest step and likewise still larger boxes on the third higher step.

Tray assemblies 26 are preferably formed with a lattice center section to reduce weight and economize on the material needed to form the unit. Each of the assemblies is further formed with upwardly extending tabs 40 at the front end and tabs 42 at the rear end of the tray assemblies. These tabs function to confine and hold a stacked length of boxes 30 from slipping off the ends of the trays.

Each tray assembly is further formed with four receptacles 44 extending outwardly from the four corners of the tray. These receptacles 44 are essentially cylindrical in configuration and are shaped and sized to receive vertically extending dowels 48. Each of the receptacles 44 is formed with a sidewall defining the cylindrical shape. In this case, the sidewall 44a is formed with a “D” shaped cross section. However, that shape may vary depending upon the particular interests or uses for the display stand. The receptacles 44 are further defined by an inwardly extending flange 45 located midway between the upper and lower edges of the receptacle sidewalls 44a forming a support for the bottom of a dowel 48 positioned in its upper end.

The dowels 48 may be formed of any suitable plastic and preferably are hollow formed for ease in manufacture. Cylindrical dowels may, if desired, be used, but preferably a hollow dowel unit is used in the preferred embodiment with the hollow dowel open on one side for ease in manufacturing and to minimize the amount of plastic required.

The four dowels on the tray assembly shown in FIG. 5 may be used to support a second tray positioned above it with similar arrangements as shown, for example, in FIG. 4, thus providing an array of six shelves. Preferably the shelves are of a height to permit this display assembly to have a vertical height extending upwardly at least to eye level. In this arrangement, the tabs 42, which as noted in FIG. 5 are somewhat larger than the tabs 40.

As illustrated in FIG. 3, an array of four tray assemblies 26 are configured into a large, rectangular shelf with seven shelves spaced in stacked array secured in fixed relation to one another by the corner dowels 48. Each shelf is stocked with horizontally parallel arrayed boxes 30 of retail goods such, for example, as candy. Signage 54 is not pre-assembled with the package. The signage 52 may be assembled with the display by inserting the lower edge of the signage into slots 49 formed at the top of the dowels 48 as illustrated in FIG. 3. See also FIGS. 3 and 4. The display contained within the shipping carton 12 on a pallet 14 and over the skirt 22 as previously described. After the shipping carton 12 is removed as shown in FIG. 2, the bottom closure is re-positioned to form a skirt 22 so that the side walls 24 are folded downwardly to cover the raw edges of the pallet 14. For a single rack, a skirt may not be desired. The side walls 24 have a finished upper surface so that this finished surface will be visible to a customer when the side walls 24 are folded downwardly as illustrated in FIG. 7. The ends of the side walls 24 are suitably shaped to interlock 52 with the ends of the adjacent side walls 24 on either side, thus forming a finished skirt appearance for the display as a whole, as best shown in FIG. 4, with the side walls 24 providing a continuous skirt about the display stand.

The ends of the side walls 24 may be provided with very standard tab and slot interlocks such as shown at 52. Other suitable interlocking methods or systems may be used including, for example, simply adhesively taping the edges together.

In a preferred embodiment an array of form tray assemblies are configured into a large rectangular shelf, with a stack of six trays with five of them stacked with boxed items as described. The boxes are initially secured in place by transparent strapping tape 50 which is removed from the exposed shelf of boxes for easy removal on sale of on dispensing.

In the preferred embodiment, the lower most tray assembly is unstocked. It may be stocked, if desired, but in general the lowermost levels of the display stand are hard to access for a customer and for floor cleaning and for that reason it may be preferable in the commercial environment to stock the upper but at least not the lowermost tray assembly.

In general, these trays will be stocked with like products. In some instances, one, two, three or four products may be displayed. For example, the company may have five different candy products and stack one product in each of the four arrays on every tray. Alternate arrangements are possible, but similar patterns may be arranged at each of the tray levels. Since the consumer will ordinarily take a box from the uppermost shelf, the store management may remove the uppermost shelf quite simply as the products are used or consumed from each shelf. The preferred embodiment discloses four racks with six levels of trays to each rack. Other configurations are readily comprehensible, including a single rack or L-shaped or C-shaped arrangements of racks. A tray assembly may also be used individually. Trays, for example, may be used as a counter display on one level or two levels or more. Other configurations and systems of use are, of course, possible including changing the number of racks or tray assemblies so as to take up less space on a convenience store counter or floor.

In one such arrangement the tray assemblies are inverted from the position shown in the drawings so that the lower surfaces of the tray assemblies are facing up. The stacked tray assemblies may be secured one above the other in the same fashion as previously described. In this configuration the tray assemblies may be used to display loose merchandise in large boxes on the now upwardly facing lower surface.

Having now described my invention, I claim:

What is claimed as new and desired to be protected by Letters Patent of the United States is:

1. A display stand for the commercial display of a plurality of like items comprising
an array of individual tray assemblies positioned laterally side by side in at least one direction, and with a plurality of such lateral trays positioned one above the other to form a stack of trays or racks, each of said tray assemblies configured to receive and display a plurality of like items;

2. A display as set forth in claim 1 in combination with a pallet upon which the display is positioned, and a removable shipping container for enclosing the display during transportation, said container configured for removal upon display of the display stand;

3. A display stand as set forth in claim 1 having four tray assemblies arranged side by side to form a larger rectangular shelf,
a plurality of dowels separating and supporting a plurality of shelves in a stacked array;

4. A display as set forth in claim 2 including a skirt positioned between the pallet and the display with the skirt extending beyond the periphery of the pallet and extending downwardly to conceal the sides of the pallet;

5. A display as set forth in claim one wherein each tray assembly is sized and shaped to support and display a plurality of like boxes in a linear array;

6. A tray assembly for use in a stackable array of tray assemblies to display a quantity of regularly shaped boxes comprising
a tray having parallel side guides along a pair of opposed edges, a longitudinally extending guide parallel to and intermediate the side guides with the guides positioned to receive and display a series of the boxes;

7. A tray assembly as set forth in claim 6 wherein each of said guides are shaped with a stepped cross section, shaped, sized and spaced to define means for selectively receiving boxes of different dimensions;

8. A tray as set forth in claim 7 wherein the tray is formed with a lattice wall;

9. A tray as set forth in claim 8 wherein the walls intermediate the side guides are provided with upwardly extending tabs sized to engage boxes positioned on the tray;

10. A tray assembly as set forth in claim 6 wherein the tray is generally rectangular in shape and is formed with receptacles at the corners of the tray shaped to receive a vertically extending dowel.

11. In combination a display stand skirt and pallet, said display stand shaped and sized for retail commercial aisle display and having a plurality of shelves upon which individual items are displayed, the skirt comprising a flat sheet of material positioned between the display stand and the pallet with the edges of the skirt extending beyond the edges of the pallet and extending downwardly to conceal the side edges of the pallet;

12. A combination as set forth in claim 11 wherein the skirt is formed with a finished upper surface.

13. A display stand as set forth in claim one wherein the individual tray assemblies have upper and lower tray surfaces, which may be selectively positioned with either facing upwardly.
